(19) United States
(12) Patent Application Publication
(10) Pub. No.: US 2014/0188594 A1
(43) Pub. Date: Jul. 3, 2014

(54) USER PHOTOGRAPH BASED ADVERTISEMENT IN A SOCIAL NETWORKING SITE

(71) Applicant: International Business Machines Corporation, (US)

(72) Inventors: Barry Alan Kritt, Raleigh, NC (US); Sarbajit Kumar Rakshit, Kolkata (IN)

(73) Assignee: INTERNATIONAL BUSINESS MACHINES CORPORATION, Armonk, NY (US)

(21) Appl. No.: 13/733,710

(22) Filed: Jan. 3, 2013

(51) Int. Cl. G06Q 30/02

(52) U.S. Cl. CPC G06Q 30/0269
USPC 705/14.43; 705/14.66

(57) ABSTRACT

An apparatus for advertising includes a photograph identification module, a photograph analysis module, a correspondence module, and an advertisement module. The photograph identification module identifies one or more photographs corresponding to a user of a social networking website. The photographs are stored by the social networking website and may include photographs uploaded by the user, photographs depicting the user, and/or photographs in which the user has been tagged. The photograph analysis module electronically analyzes the photographs to determine at least one characteristic of a person, object, and/or location depicted in the photographs. The correspondence module identifies a product and/or service corresponding to the characteristic, and the advertisement module sends an advertisement for the product or service to the user.

### BACKGROUND

1. Field

The subject matter disclosed herein relates to advertisement and more particularly relates to advertisement based on photographs on a social networking website.

2. Description of the Related Art

Many internet users often use social networking websites to connect with other people on the internet for personal or professional purposes. Information about users of social networking websites is often used by advertisers to tailor advertisements to users' interests. In fact, if the effectiveness of a social networking site depends on the size of its network of users, the site may be free, or have a low cost to users, and may be primarily financially supported by advertisers.

Some social networking websites allow users to upload photographs. Users may provide additional information and commentary by captioning photographs, or by tagging people or locations depicted in the photographs. As with other information about users, information about users' photographs may be used for advertising purposes.

### BRIEF SUMMARY

A method for advertising is disclosed. An apparatus and computer program product also perform the functions of the method. The method includes identifying one or more photographs corresponding to a user of a social networking website. The photographs are stored by the social networking website and may include photographs uploaded by the user, photographs depicting the user, and/or photographs in which the user has been tagged. The method includes electronically analyzing the photographs to determine at least one characteristic of a person, object, and/or location depicted in the photographs. In one embodiment, the method includes identifying a product and/or service corresponding to the characteristic. In a further embodiment, the method includes sending an advertisement for the product or service to the user.

In one embodiment, electronically analyzing the one or more photographs includes using one or more of face recognition software and object recognition software to determine the at least one characteristic. In another embodiment, electronically analyzing the one or more photographs includes making an initial determination of the at least one characteristic and changing the initial determination in response to feedback received from the user. In another embodiment, determining the at least one characteristic includes referencing at least one tag associated with the one or more photographs on the social networking website. In a further embodiment, the method includes using information associated with the at least one tag to identify the product or service. The information includes an interest of a person tagged in the one or more photographs, a relationship of a person tagged in the one or more photographs to the user, and/or an identity of a location tagged in the one or more photographs.

In one embodiment, sending an advertisement for the product or service to the user includes displaying the advertisement with a web page of the social networking website accessed by the user, emailing the advertisement, and/or mailing the advertisement. In another embodiment, the method includes determining a priority for each photograph of the one or more photographs where the priority is based on a date associated with the photograph, a person who uploaded the photograph to the social networking website, an album on the social networking website including the photograph, a relationship of a person depicted in the photograph to the user, and/or the person, object, or location being depicted in more than one of the one or more photographs. In the embodiment, the method also includes using the priority to identify the product or service.

In another embodiment, the method includes searching the social networking website for photographs. In another embodiment, identifying the one or more photographs is in response to the user uploading a photograph to the social networking website. In another embodiment, the product or service corresponds to a type of location depicted in the one or more photographs, an activity related to an object depicted in the one or more photographs, an activity related to a location depicted in the one or more photographs, and/or a gift for a person depicted in the one or more photographs.

An apparatus for advertising includes a photograph identification module, a photograph analysis module, a correspondence module, and an advertisement module. The photograph identification module identifies one or more photographs corresponding to a user of a social networking website. The photographs are stored by the social networking website and may include photographs uploaded by the user, photographs depicting the user, and/or photographs in which the user has been tagged. The photograph analysis module electronically analyzes the photographs to determine at least one characteristic of a person, object, and/or location depicted in the photographs. The correspondence module identifies a product and/or service corresponding to the characteristic, and the advertisement module sends an advertisement for the product or service to the user. In one embodiment, at least a portion of the photograph identification module, the photograph analysis module, the correspondence module, and the advertisement module include hardware and/or executable code where the executable code is stored on one or more computer readable storage media

In one embodiment, the photograph analysis module includes a recognition module that uses one or more of face recognition software and object recognition software to determine the at least one characteristic. In another embodiment, the photograph analysis module includes a feedback module that makes an initial determination of the at least one characteristic and changes the initial determination in response to feedback received from the user.

In another embodiment, the photograph analysis module determines the at least one characteristic by referencing at least one tag associated with the one or more photographs on the social networking website and the correspondence module uses information associated with the at least one tag to identify the product or service where the information includes an interest of a person tagged in the one or more photographs, a relationship of a person tagged in the one or more photographs to the user, and/or an identity of a location tagged in the one or more photographs. In another embodiment, the advertisement module sends an advertisement for the product or service to the user by displaying the advertisement with a web page of the social networking website accessed by the user, emailing the advertisement, and/or mailing the advertisement.

In one embodiment, the apparatus includes a priority determination module that determines a priority for each photograph of the one or more photographs where the priority is based on a date associated with the photograph, a person who uploaded the photograph to the social networking website, an album on the social networking website including the photograph, a relationship of a person depicted in the photograph to the user, and/or the person, object, or location being depicted in more than one of the one or more photographs where the correspondence module uses the priority to identify the product or service. In another embodiment, the apparatus includes comprising a search module that searches the social networking website for photographs.

In another embodiment, the photograph identification module identifies one or more photographs in response to the user uploading a photograph to the social networking website. In another embodiment, the product or service corresponds to a type of location depicted in the one or more photographs, an activity related to an object depicted in the one or more photographs, an activity related to a location depicted in the one or more photographs, and/or a gift for a person depicted in the one or more photographs.

A computer program product for advertising is included. The computer program product includes a computer readable storage medium having program code embodied thereon. The program code is readable and/or executable by a processor to identify one or more photographs corresponding to a user of a social networking website. The photographs are stored by the social networking website and may include photographs uploaded by the user, photographs depicting the user, and/or photographs in which the user has been tagged. The program code is readable and/or executable by a processor to electronically analyze the photographs to determine at least one characteristic of a person, object, and/or location depicted in the photographs. In one embodiment, the program code is readable and/or executable by a processor to identify a product and/or service corresponding to the characteristic, and to send an advertisement for the product or service to the user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for advertising;

FIG. 2 is a schematic block diagram illustrating one embodiment of an apparatus for advertising;

FIG. 3 is a schematic block diagram illustrating another embodiment of an apparatus for advertising;

FIG. 4 is a schematic flow chart diagram illustrating one embodiment of a method for advertising;

FIG. 5 is a schematic flow chart diagram illustrating another embodiment of a method for advertising; and

FIG. 6 is an example of a web page illustrating one embodiment of photograph based advertising.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

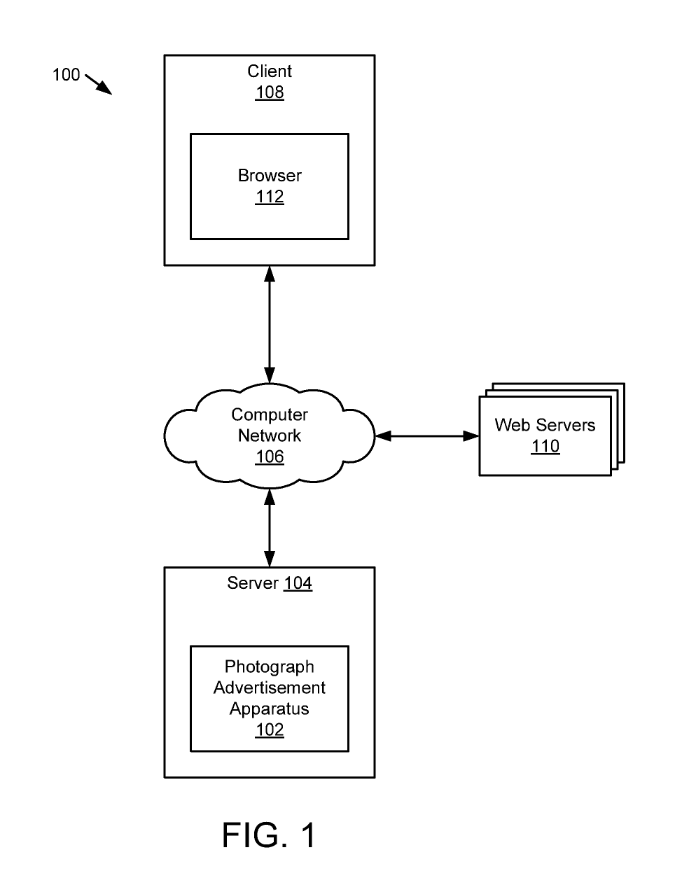

FIG. 1 is a schematic block diagram illustrating one embodiment of a system 100 for advertising. The system 100 includes a photograph advertisement apparatus 102 on a server 104, a computer network 106, a client 108 with a browser 112, and web servers 110, which are described below.

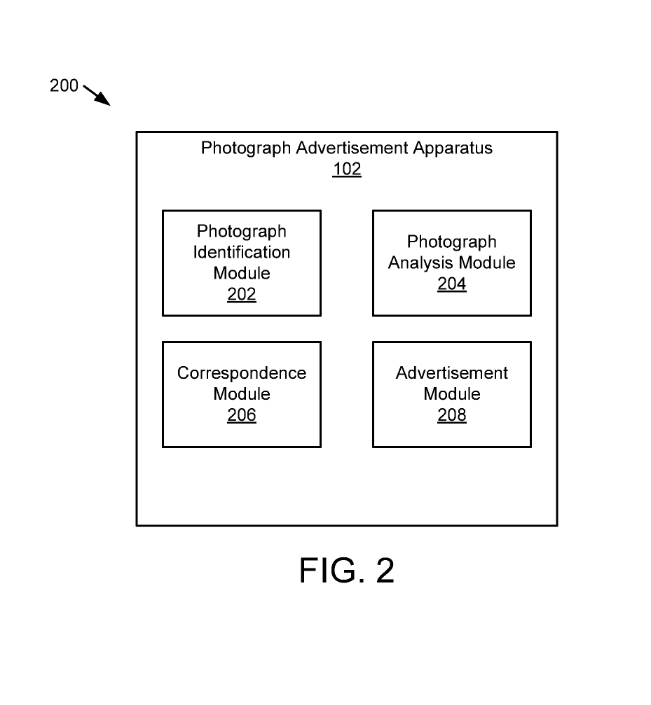

In one embodiment, the system 100 includes a photograph advertisement apparatus 102 on a server 104. The photograph advertisement apparatus 102 electronically analyzes photographs to advertise to a user of a social networking site. The photograph advertisement apparatus 102 is described in more detail with respect to the apparatus 200 of FIG. 2. The server 104 may be a mainframe computer, a blade server, a workstation, a desktop computer, or other computer. The server 104, in one embodiment, includes a plurality of processors, such as a partitioned mainframe with multiple operating system instances. In another embodiment, the server 104 includes one or more subsystems, such as a storage area network. The server 104 may access internal storage or external storage accessible through a network. In one embodiment, the server 104 is a server associated with a social networking website. For example, the server 104 may be part of a server farm controlled by a company that provides a social networking website. In another embodiment, the server 104 may be associated with an advertiser. For example, the server 104 may be a controlled by an advertiser to crawl the internet for content upon which advertisements can be based. In a different embodiment, the server 104 may not be associated with a particular social networking website or advertiser.

The system 100 includes a computer network 106 in communication with the server 104, the client 108, and web servers 110. The computer network 106 may be a single network or may include several computer networks 106 linked together. The computer network 106 may include a local area network (“LAN”), wide area network (“WAN”), wireless network, etc. The computer network 106 may include hardware such as the server 104, routers, switches, cabling, and other communication hardware. The computer network 106 may also include computer readable storage media, such as a hard disk drive, an optical drive, non-volatile memory, random access memory (“RAM”), or the like. The computer network 106 may include the internet and access remote web servers 110 with web pages of a social networking website. Web pages available to the photograph advertisement apparatus 102 may be located within a proprietary computer network 106, such as within servers 104, web servers 110, etc. hosting a private social networking site for members only, or may be located external to a proprietary computer network 106 and may be available for public access. Web pages may include data about users' interests, user photographs, blog posts, music, files, or any other content of a social networking site. One of skill in the art will recognize other content of social networking websites available for access by a client 108 or server 104 over one or more computer networks 106.

The client 108 may be a desktop computer, laptop computer, netbook, tablet, mobile phone, or the like. The browser 112, in one embodiment, is an application installed on the client 108. In another embodiment, the browser 112 is located external to the client 108, for example on a server 104, storage area network, a cloud device, or the like, but is accessed by the client 108. In one embodiment, the photograph advertisement apparatus 102 sends advertisements over the computer network 106 to the client 108 to be displayed by a browser 112 along with a web page of a social networking website.

FIG. 2 is a schematic block diagram illustrating one embodiment of an apparatus 200 for advertising. In one embodiment, the apparatus 200 includes a photograph advertisement apparatus 102 with a photograph identification module 202, a photograph analysis module 204, a correspondence module 206, and an advertisement module 208, which are described below.

In general, the apparatus 200 identifies and analyzes photographs on a social networking website in order to send targeted advertisements to the website's users. In one embodiment, a “social networking website” may refer to a website which facilitates online or real-life social relations among its users. Many social networking websites allow users to post and share content they have created, such as photographs, ideas, and content about events or interests. Content may be shared publicly, or only with certain people. One of skill in the art will recognize other types of social networking websites and other characteristics of social networking websites.

The apparatus 200, in one embodiment, includes a photograph identification module 202 that identifies one or more photographs stored by a social networking website and corresponding to a user of the website, for analysis by the photograph analysis module 204. The photograph identification module 202 may identify a single photograph for advertising purposes, or may identify multiple photographs.

In one embodiment, “photographs corresponding to a user” may mean that the photographs are associated with the user in some way on the social networking website. Thus, information in or about the photographs corresponding to a user are possibly useful for targeting advertisements to that user. In one embodiment, a photograph may correspond to the user because it was uploaded to the social networking website by the user. In another embodiment, a photograph may correspond to the user because it depicts the user, even if the photograph was uploaded by another person. The photograph identification module 202 may identify photographs depicting a user by checking tags, captions, and/or other information associated with the photograph, or by using facial recognition software, or similar methods. In a further embodiment, a photograph may correspond to the user because the user is tagged in the photograph.

In one embodiment, a “tag” is a label that has been associated with a photograph and/or portion of a photograph, on the social networking site. Thus, a user is “tagged” in a photograph if someone on the social networking site adds a tag (i.e., label) to the photograph, and the tag indicates the user's identity. Tags are often used to label persons, objects and or locations which are depicted in a photograph, but may also be used for other reasons. For example, if a social networking website notifies users when they are tagged in someone's photographs, a person may tag a photograph with a user's name, even if the user is not depicted in the photograph, in order to bring that photograph to the user's attention. For example, a person may tag a photograph by adding a comment about the photograph and the comment may identify the user. Even if a user is not depicted in a photograph, the fact that the user is tagged in the photograph may indicate that the photograph is associated with the user in some way that may be useful for advertising.

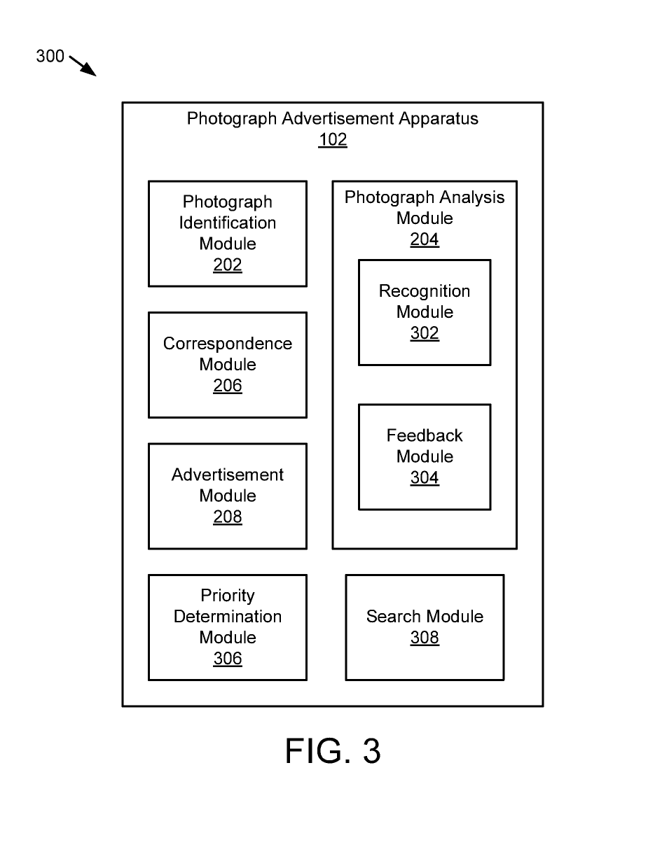

In one embodiment, the photograph identification module 202 may identify one or more photographs in response to the user uploading a photograph to the social networking website. For example, if a user uploads a new album of vacation pictures to a social networking website, the photograph identification module 202 may be triggered by the upload, so that the apparatus 200 can send advertisements to the user that are related to the user's vacation. In another embodiment, the photograph identification module 202 may identify one or more photographs in response to an electronic search for photographs, as described below with respect to the search module 308 of FIG. 3.

The apparatus 200, in one embodiment, includes a photograph analysis module 204 that electronically analyzes the photographs to determine at least one characteristic of persons, objects, or locations depicted in the photographs. In one example, a “characteristic” may refer to an attribute of what is depicted, including the identity attribute and other attributes. For example, in one embodiment, determining a characteristic of a person may include determining an attribute such as the person's identity, the person's relationship to the user, whether the person is a newlywed, whether the person is a baby, whether the person is using an object depicted in the photograph, an interest of the person, or the like. Similarly, in another embodiment, determining a characteristic of an object may include determining what the object is, what the object is used for, a size of the object, or the like. For example, the photograph analysis module 204 may determine that an object depicted in a photograph is a small fishing boat, which suggests that advertisements related to sport fishing may be successful. In a further embodiment, determining a characteristic of a location may involve identifying a particular location from something at the location, such as the Washington Monument for identifying Washington D.C., or a type of location, such as a tropical beach, snow-covered mountain, or the like. In various embodiments the photograph analysis module 204 can identify various characteristics.

In various embodiments, the photograph analysis module 204 may use face or object recognition software to determine a characteristic. In a particular embodiment, the photograph analysis module 204 may change an initial determination of a characteristic based on user feedback, as described below with respect to the recognition module 302 and the feedback module 304 of FIG. 3. In one embodiment, the photograph analysis module 204 may determine at least one characteristic by referencing at least one tag associated with the photographs on the social networking website. For example, in a certain embodiment, the photograph analysis module 204 may determine the identity characteristic of a person depicted in the photograph by referencing a tag which identifies the person. Similarly, in another embodiment, the photograph analysis module 204 may determine that a location is tropical by referencing a tag which identifies the location. For example, a tag may list a location as Hawaii.

The apparatus 200 includes a correspondence module 206 that identifies one or more products and/or services corresponding to the at least one characteristic determined by the photograph analysis module 204, in order to target advertising to the user. In general, the correspondence module 206 identifies products or services that the user is likely to buy, based on an analysis of the user's photographs, so that advertisements for those products or services can be sent to the user. In one embodiment, the correspondence module 206 may identify a product or service corresponding to one or some characteristics determined by the photograph analysis module 204 while ignoring other characteristics determined by the photograph analysis module 204. In another embodiment, the correspondence module 206 may use all the characteristics determined by the photograph analysis module 204 to identify a product and/or service. For example, if the photograph analysis module 204 determines characteristics including that an object in a photograph is a fishing boat, the correspondence module 206 may identify products and/or services corresponding to fishing, boats, or both.

In one embodiment, the correspondence module 206 identifies products and/or services corresponding to a type of location depicted in the photographs. For example, if the type of location depicted in the photographs is a snow-covered mountaintop, the correspondence module 206 may identify skiing products and/or services. In another embodiment, the correspondence module 206 identifies products and/or services corresponding to an activity related to an object depicted in the photographs. For example, if the object depicted in the photographs is a football, the correspondence module 206 may identify products and/or services corresponding to the activity of playing football or attending a football game. In a certain embodiment, the correspondence module 206 identifies products and/or services corresponding to an activity related to a location depicted in the photographs. For example, if the location depicted in the photographs is at the Washington Monument, the correspondence module 206 may identify products and/or services corresponding to the activity of tourism.

In a further embodiment, the correspondence module 206 identifies products and/or services corresponding to a gift for a person depicted in the photographs. For example, if the person depicted in the photographs is the user's spouse, the correspondence module 206 may identify potential anniversary gifts. The correspondence module 206 may use information from the social networking website about the person depicted in the photographs to determine likely gifts. For example, if the person is tagged, the tags may indicate the identity of the person, and other information about that person on the social networking site may indicate their relationship to the user. Other information about a spouse may include a wedding date available on the social networking website, and the correspondence module 206 may use the wedding date to make timely anniversary gift suggestions, and suggest other gifts at other times. Other information on the social networking site that the correspondence module 206 may use to identify gift suggestions may include birth dates, interests of the person depicted in the photographs, characteristics determined from the photographs by the photograph analysis module 204, pages on the social networking site frequently viewed by the person, etc.

In embodiments of the apparatus 200 where the photograph analysis module 204 determines a characteristic by referencing tags associated with the photographs on the social networking website, the correspondence module 206 may use information associated with the tags to identify products and/or services corresponding to the characteristic. In one embodiment, the information associated with the tags may be an interest of a person tagged in the one or more photographs. For example, a person tagged in the photographs may be tagged with the person's name, and information associated with that name (i.e., the tag) may indicate interests of that person as depicted in other photographs where the person is tagged, listed on a profile page for the person, shared by multiple people in the person's social network, or the like. In another embodiment, the information associated with the tags may be a relationship of a person tagged in the one or more photographs to the user. For example, information associated with the same tagged person's name may indicate that the tagged person is the user's spouse. In either case, the correspondence module 206 could use information about the person's interests to identify products and/or services as possible gifts for that person.

In a further embodiment, the information associated with the tags may be an identity of a location tagged in the one or more photographs. For example, a photograph's location may be tagged as a city where the photograph was taken, and the correspondence module 206 could use the name of the city to identify local products and/or services for that city.

The apparatus 200 includes an advertisement module 208 that sends one or more advertisements for the products and/or services identified by the correspondence module 206 to the user. In one embodiment, the advertisement module 208 sends an advertisement when the user views one of the photographs. In another embodiment, the advertisement module 208 sends an advertisement when the user views a page of the social networking website with information about a person depicted in the photograph, such as a profile page. For example, if the person is viewing a page of information about a relative, the advertisement might suggest gifts for that relative. In yet another embodiment, the advertisement module 208 may send the advertisement for display with a web page of another web site. In various embodiments, the advertisement module 208 may send the advertisement at various times.

The advertisement may be a banner or sidebar advertisement for display as part of a web page, a pop-up or pop-under advertisement for display when a web page is accessed, an email advertisement, a direct mail advertisement, or another type of advertisement. In one embodiment, the advertisement module 208 sends an advertisement for the product or service to the user by displaying the advertisement with a web page of the social networking website accessed by the user. In a certain embodiment, the advertisement module 208 sends the advertisement for display by another website. In another embodiment, the advertisement module 208 emails the advertisement to the user. In still another embodiment, the advertisement module 208 mails a non-electronic advertisement to the user.

FIG. 3 is a schematic block diagram illustrating another embodiment of an apparatus 300 for advertising. The apparatus 300 includes an embodiment of the photograph advertisement apparatus 102 with a photograph identification module 202, a photograph analysis module 204, a correspondence module 206, and an advertisement module 208, which are substantially similar to those described above in relation to the apparatus 200 of FIG. 2. The photograph advertisement apparatus 102, in various embodiments, may include a priority determination module 306 and a search module 308, which are described below. The photograph analysis module 204, in the depicted embodiment, may include a recognition module 302 and a feedback module 304, which are also described below.

The apparatus 300, in one embodiment, includes a priority determination module 306 that determines a priority for each photograph of the one or more photographs identified by the photograph identification module 202. The priority determination module 306, in various embodiments, may use priorities which include bifurcated high and low priorities, intermediate priorities, numeric priorities on a sliding scale, aggregate priorities for sets of photographs, or the like. In a further embodiment, the correspondence module 206 may use the priority of photographs to identify products and/or services for targeted advertising. For example, if a first location is depicted in high priority photographs and a second location is depicted in lower priority photographs, the correspondence module 206 may preferentially identify products and/or services corresponding to characteristics of the first location.

In one embodiment, the priority determination module 306 may determine a priority for a photograph based on a date associated with the photograph. A date associated with a photograph may include the date the photograph was taken, the date the photograph was uploaded to the social networking website, or the like. For example, in a certain embodiment, the priority determination module 306 may assign higher priorities to more recently uploaded photographs, so that advertising will be targeted to the user's recent interests rather than interests from several years in the past. In another embodiment, the priority determination may assign a higher priority to photographs taken before a date threshold, because the effort to scan and digitize old photographs before uploading them to a social networking site may indicate the significance of those photographs to the user.

In one embodiment, the priority determination module 306 may determine a priority for a photograph based on a person who uploaded the photograph to the social networking website. For example, the priority determination module 306 may assign a higher priority to photographs uploaded by the user, and a lower priority to photographs in which the user is tagged which were uploaded by another person, because the photographs uploaded by the user himself or herself may more accurately reflect the user's interests.

In one embodiment, the priority determination module 306 may determine a priority for a photograph based on an album on the social networking website including the photograph. In one embodiment, an “album” refers to any grouping of pictures on the social networking website, and may include albums created by the user, albums automatically created by the website, or the like. In one embodiment, for example, an album entitled “picture dump” may include multiple unrelated photographs, and so the pictures in that album may receive a lower priority from the priority determination module 306 than pictures in other albums would.

Some albums, however, may have special significance in the social networking site. For example, on one social networking site, a profile pictures album may include only one picture, which appears next to the user's name in multiple places on the website, or may include multiple pictures used in that way over the lifetime of the user's account. Because other people will associate those pictures with the user, people or objects depicted in the profile pictures may have higher significance to the user. For example, if the profile picture prominently depicts a baby, it may be that that person is the user's child, rather than a baby who was coincidentally in the frame of the photograph. Similarly, more avid fans of a football team may have that team's logo depicted in their profile pictures, while more casual fans may not. Accordingly, the priority determination module 306 may assign a higher priority to photographs in the profile pictures album, so that the correspondence module 206 can identify relevant products and/or services.

In one embodiment, the priority determination module 306 may determine a priority for a photograph based on a relationship of a person depicted in the photograph to the user. For example, in one embodiment, the social networking site may have information about the user's family members, and photographs depicting the user's family members may receive a higher priority than photographs without family members, so that the correspondence module 206 can identify products and/or services appropriate for activities enjoyed by the family.

In another embodiment, the priority determination module 306 may determine a priority for a photograph based on a person, object, or location being depicted in more than one of the one or more photographs. For example, even if the social networking site does not have information about the user's family members, the priority determination module 306 may determine that a photograph which depicts a person who is also depicted in multiple other photographs should have a higher priority, because that person is likely significant to the user, and products and/or services corresponding to that person's interests may be good gift suggestions to advertise. Similarly, if a user's pictures frequently depict a ski resort but depict a tropical beach only once, it may be likely that advertisements relating to skiing will be more relevant to the user than advertisements relating to beaches, and the priority determination module 306 may determine a higher priority for the ski resort pictures, and a lower priority for the beach picture. One of skill in the art will recognize that the priority determination module 306 may determine a priority for a photograph based on various combinations of the factors discussed above, and/or other factors.

The apparatus 300, in one embodiment, includes a search module 308 that searches the social networking website for photographs. For example, in one embodiment, the search module 308 may crawl the web, including multiple social networking sites, searching for photographs and the photograph identification module 202 may identify photographs corresponding to the user in response to the search module 308 returning photographs in search results. In another embodiment, the search module 308 may crawl a specific social networking site to search for photographs without searching the web more generally.

In one embodiment, the photograph analysis module 204 may include a recognition module 302 that electronically analyzes the photographs using face recognition software and/or object recognition software, to determine the at least one characteristic. For example, in some embodiments, the recognition module 302 can use face recognition software to determine the identities of people depicted in the photographs, regardless of whether the people are tagged. In another embodiment, the recognition module 302 may use object recognition software to determine the identity of objects in the photograph such as a boat, a football, or a mountain, so that the correspondence module 206 can identify appropriate products and/or services.

In another embodiment, the photograph analysis module 204 includes a feedback module 304 so that the photograph analysis module 204 makes an initial determination of at least one characteristic, and the feedback module 304 changes the initial determination in response to feedback received from a user. For example, in one embodiment, the photograph analysis module 204 could present an initial determination of a location characteristic to the user as a proposed location tag for the photographs, and the feedback module 304 could change the determination if the user accepts, rejects, or edits the proposed location.

In some embodiments, the recognition module 302 and the feedback module 304 may cooperate to electronically analyze the photographs. For example, in one embodiment, the recognition module 302 may use facial recognition software to initially determine the identities of people depicted in the photographs, and then present that initial determination to the user as a preliminary set of tags for the photographs. In one embodiment, the user may add a tag after the photograph analysis module 204 identifies a characteristic and the feedback module 304 may recognize the tag as more accurate information and may change initial determination of the characteristic. In another embodiment, the feedback module 304 could interact with a user, for example by sharing the characteristic determined by the photograph analysis module 204 with the user and the feedback module 304 could allow the user to accept, edit, or remove the presented tags and change the initial determination of the peoples' identities in response to the user's feedback. In certain embodiments, using a recognition module 302 to make an initial determination of characteristics, and then using the feedback module 304 to change that determination, allows users to partially automate the process of tagging photographs, and improves the information available to target advertisements to the user.

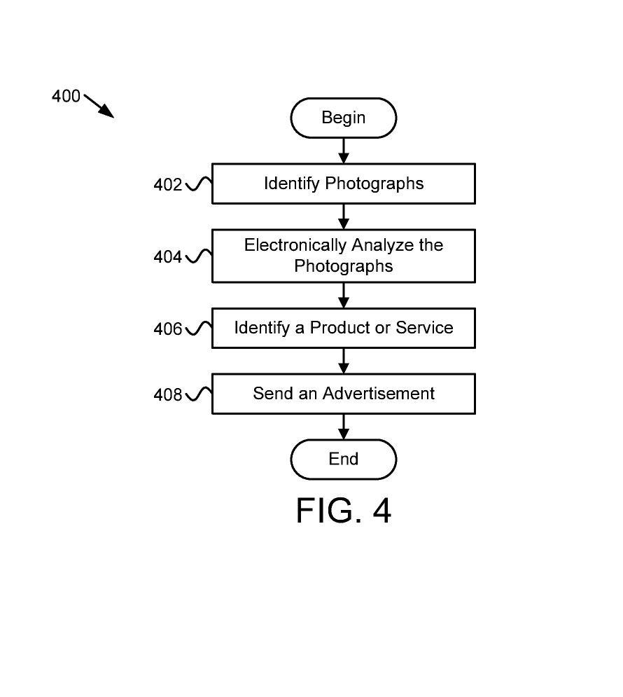

FIG. 4 is a schematic flow chart diagram illustrating one embodiment of a method 400 for advertising. The method 400 begins and identifies 402 one or more photographs corresponding to a user of a social networking site. For example, in one embodiment, the photograph identification module 202 identifies 402 the photographs. The photographs may be stored by the social networking website and may include photographs uploaded by the user, photographs depicting the user, and/or photographs in which the user has been tagged. The method 400 electronically analyzes 404 the photographs to determine at least one characteristic of a person, object, and/or location depicted in the photographs. For example, in one embodiment, the photograph analysis module 204 electronically analyzes 404 the photographs. The method 400 identifies 406 a product or service corresponding to the characteristic. For example, in one embodiment, the correspondence module 206 identifies 406 the product or service. The method 400 sends 408 an advertisement for the product or service to the user, and the method 400 ends. In one embodiment, the advertisement module 208 sends 408 the advertisement.

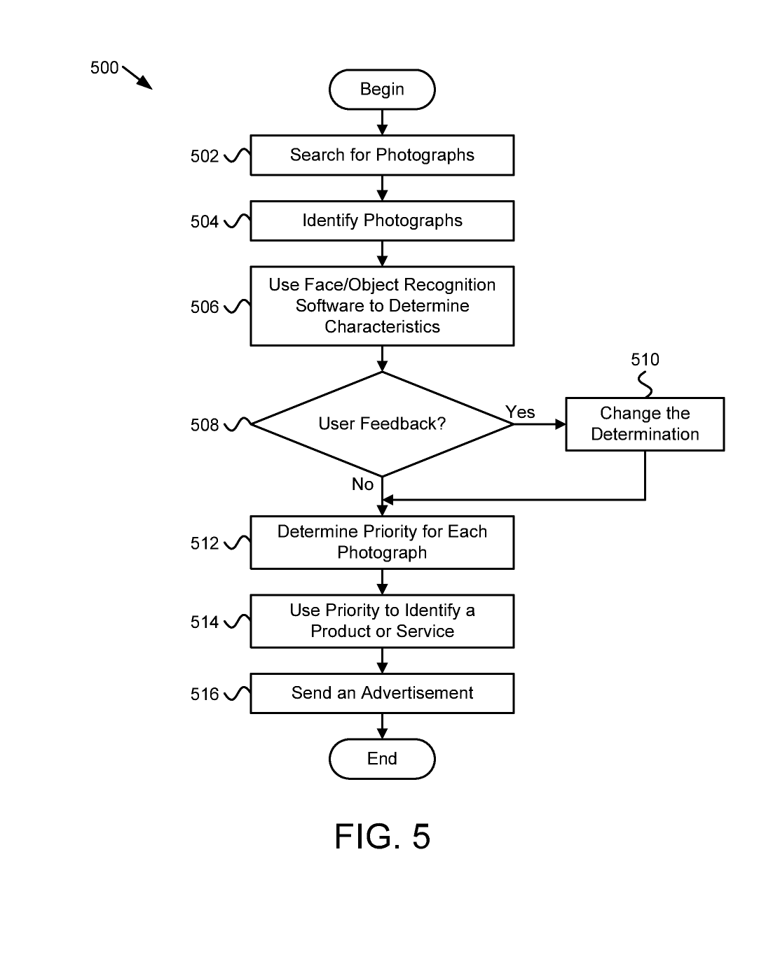

FIG. 5 is a schematic flow chart diagram illustrating another embodiment of a method 400 for advertising. The method 500 begins and searches 502 a social networking site for photographs. For example, in one embodiment, the search module 308 searches 502 the social networking site for photographs by crawling the web. The method 500 identifies 504 one or more photographs corresponding to a user of a social networking site. For example, in one embodiment, the photograph identification module 202 identifies 504 the photographs. The photographs may be stored by the social networking website and may include photographs uploaded by the user, photographs depicting the user, and/or photographs in which the user has been tagged.

In one embodiment, the method 500 uses 506 face or object recognition software to determine at least one characteristic of a person, object, and/or location depicted in the photographs. For example, in one embodiment, the recognition module 302 uses 506 face or object recognition software to electronically analyze the photographs and determine a characteristic. The method 500 optionally determines 508 if user feedback regarding the characteristic is available. If the method 500 determines 508 that user feedback exists, the method 500 changes 510 the initial determination of the characteristic in response to feedback received from the user. For example, in one embodiment, the feedback module 304 may change 510 the initial determination of a characteristic in response to user feedback. In response to changing 510 the initial determination, or if the method 500 determines 508 that no user feedback is available, the method 500 determines 512 a priority for each photograph. In one embodiment, the priority determination module 306 determines 512 priorities of the photographs. The method 500 uses 514 the priority of the photographs to identify a product or service corresponding to the characteristic. In one embodiment, the correspondence module 206 uses 514 the priority to identify the product or service. The method 500 sends 516 an advertisement for the product or service to the user, and the method 500 ends. In one embodiment, the advertisement module 208 sends 516 the advertisement.

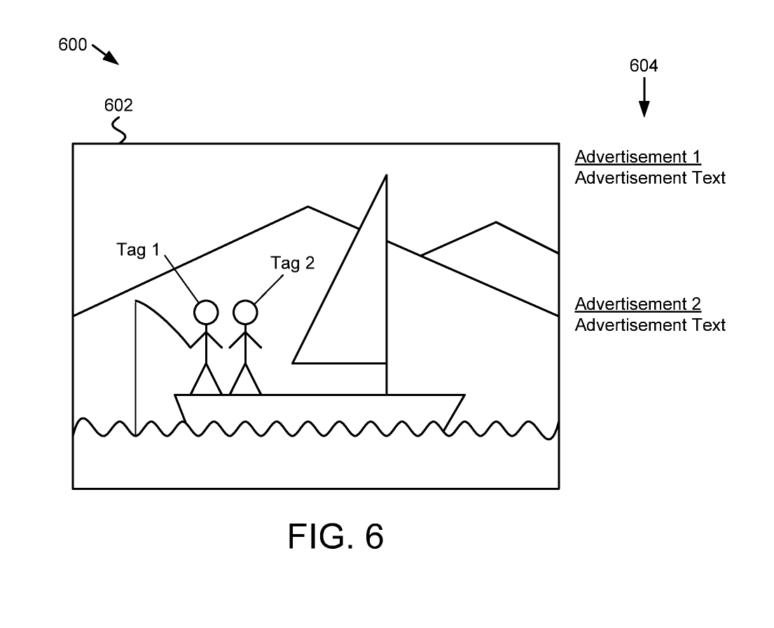

FIG. 6 is an example of a web page 600 illustrating one embodiment of photograph based advertising. In the embodiment, the web page 600 includes a photograph 602 and advertisements 604. In one embodiment, a browser 112 may display the web page 600 on a client 108. The photograph 602 depicts one or more of a person, an object, and a location, and characteristics of the depicted persons, objects, or locations may be used to determine which advertisements 604 are displayed. In one embodiment, the photograph 602 may depict a person fishing so that advertisements 604 for fishing gear or fishing tours are displayed. In a further embodiment, a tag associated with the photograph 602 indicates that the user is the person depicted fishing, so that fishing advertisements 604 are prioritized over other advertisements 604. In another embodiment, the photograph 602 may depict a second person, and a tag may indicate the identity of the second person. Information about that person on the social networking website may indicate that the second person is the user's sibling. The presence of the user's sibling in the photograph 602 may suggest a close relationship between the user and the sibling, so the advertisements 604 may suggest gifts based on the sibling's interests, or common interests of the sibling and the user.

In another embodiment, characteristics of objects depicted in the photograph 602 may be identified, such as a sailboat or fishing pole. In that case, one or more of the advertisements 604 may suggest products and/or services related to fishing, boating or both. In a further embodiment, characteristics of locations depicted in the photograph 602 may be identified. The characteristics may be general or specific. For example, tags or captions associated with the photograph 602 may indicate that it depicts fishing off the coast of Hawaii, or the photograph 602 may be electronically analyzed to determine, more generally, that it depicts a seaside location. Accordingly, advertisements 604 may suggest products or services related to fishing, Hawaii, the seaside generally, or other seaside activities. In general, the advertisements 604 may be for products or services corresponding to a location or type of location depicted in the photograph 602 (or other photographs of the user), an activity related to an object or location depicted in the photograph 602, gifts for a person depicted in the photograph 602 or other depicted characteristics.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
identifying one or more photographs corresponding to a user of a social networking website, wherein the one or more photographs are stored by the social networking website and the one or more photographs comprise one or more of a photograph uploaded by the user, a photograph depicting the user, and a photograph in which the user has been tagged;
electronically analyzing the one or more photographs to determine at least one characteristic of one or more of a person, an object, and a location depicted in the one or more photographs;
identifying one or more of a product and a service corresponding to the at least one characteristic; and
sending an advertisement for the product or service to the user.

2. The method of claim 1, wherein electronically analyzing the one or more photographs comprises using one or more of face recognition software and object recognition software to determine the at least one characteristic.

3. The method of claim 1, wherein electronically analyzing the one or more photographs comprises making an initial determination of the at least one characteristic and changing the initial determination in response to feedback received from the user.

4. The method of claim 1, wherein determining the at least one characteristic comprises referencing at least one tag associated with the one or more photographs on the social networking website.

5. The method of claim 4, further comprising using information associated with the at least one tag to identify the product or service, the information comprising one or more of an interest of a person tagged in the one or more photographs, a relationship of a person tagged in the one or more photographs to the user, and an identity of a location tagged in the one or more photographs.

6. The method of claim 1, wherein sending an advertisement for the product or service to the user comprises one or more of displaying the advertisement with a web page of the social networking website accessed by the user, emailing the advertisement, and mailing the advertisement.

7. The method of claim 1, further comprising:
determining a priority for each photograph of the one or more photographs, the priority based on one or more of a date associated with the photograph, a person who uploaded the photograph to the social networking website, an album on the social networking website including the photograph, a relationship of a person depicted in the photograph to the user, and the person, object, or location being depicted in more than one of the one or more photographs; and
using the priority to identify the product or service.

8. The method of claim 1, further comprising searching the social networking website for photographs.

9. The method of claim 1, wherein identifying the one or more photographs is in response to the user uploading a photograph to the social networking website.

10. The method of claim 1, wherein the product or service corresponds to one or more of a type of location depicted in the one or more photographs, an activity related to an object depicted in the one or more photographs, an activity related to a location depicted in the one or more photographs, and a gift for a person depicted in the one or more photographs.

11. An apparatus comprising:
a photograph identification module that identifies one or more photographs corresponding to a user of a social networking website, wherein the one or more photographs are stored by the social networking website and the one or more photographs comprise one or more of a photograph uploaded by the user, a photograph depicting the user, and a photograph in which the user has been tagged;
a photograph analysis module that electronically analyzes the one or more photographs to determine at least one characteristic of one or more of a person, an object, and a location depicted in the one or more photographs;
a correspondence module that identifies one or more of a product and a service corresponding to the at least one characteristic; and
an advertisement module that sends an advertisement for the product or service to the user,
wherein at least a portion of the photograph identification module, the photograph analysis module, the correspondence module, and the advertisement module comprise one or more of hardware and executable code, the executable code stored on one or more computer readable storage media.

12. The apparatus of claim 11, wherein the photograph analysis module comprises a recognition module that uses one or more of face recognition software and object recognition software to determine the at least one characteristic.

13. The apparatus of claim 11, wherein the photograph analysis module comprises a feedback module that makes an initial determination of the at least one characteristic and changes the initial determination in response to feedback received from the user.

14. The apparatus of claim 11, wherein:
the photograph analysis module determines the at least one characteristic by referencing at least one tag associated with the one or more photographs on the social networking website; and
the correspondence module uses information associated with the at least one tag to identify the product or service, the information comprising one or more of an interest of a person tagged in the one or more photographs, a relationship of a person tagged in the one or more photographs to the user, and an identity of a location tagged in the one or more photographs.

15. The apparatus of claim 11, wherein the advertisement module sends an advertisement for the product or service to the user by one or more of displaying the advertisement with a web page of the social networking website accessed by the user, emailing the advertisement, and mailing the advertisement.

16. The apparatus of claim 11, further comprising:
a priority determination module that determines a priority for each photograph of the one or more photographs, the priority based on one or more of a date associated with the photograph, a person who uploaded the photograph to the social networking website, an album on the social networking website including the photograph, a relationship of a person depicted in the photograph to the user, and the person, object, or location being depicted in more than one of the one or more photographs,
wherein the correspondence module uses the priority to identify the product or service.

17. The apparatus of claim 11, further comprising a search module that searches the social networking website for photographs.

18. The apparatus of claim 11, wherein the photograph identification module identifies one or more photographs in response to the user uploading a photograph to the social networking website.

19. The apparatus of claim 11, wherein the product or service corresponds to one or more of a type of location depicted in the one or more photographs, an activity related to an object depicted in the one or more photographs, an activity related to a location depicted in the one or more photographs, and a gift for a person depicted in the one or more photographs.

20. A computer program product for advertising, the computer program product comprising a computer readable storage medium having program code embodied therein, the program code readable/executable by a processor to:
identify one or more photographs corresponding to a user of a social networking website, wherein the one or more photographs are stored by the social networking website and the one or more photographs comprise one or more of a photograph uploaded by the user, a photograph depicting the user, and a photograph in which the user has been tagged;
electronically analyze the one or more photographs to determine at least one characteristic of one or more of a person, an object, and a location depicted in the one or more photographs;
identify one or more of a product and a service corresponding to the at least one characteristic; and
send an advertisement for the product or service to the user.
